(19) United States
(12) Patent Application Publication
(10) Pub. No.: US 2025/0155224 A1
(43) Pub. Date: May 15, 2025

(54) SYSTEMS AND METHODS FOR REMOTELY DEPLOYING A VEHICULAR TIRE DEFLATION DEVICE

(71) Applicants: Stop Stick, Ltd., Harrison, OH (US); Tactical R/C LLC, Lakeville, MN (US)

(72) Inventors: Andrew S. Morrison, Loveland, OH (US); Shawn Mahaney, Lakeville, MN (US); Joshua Dean, Lakeville, MN (US)

(21) Appl. No.: 18/946,466

(22) Filed: Nov. 13, 2024

Related U.S. Application Data
(60) Provisional application No. 63/598,625, filed on Nov. 14, 2023.

(51) Int. Cl. F41H 11/10

(52) U.S. Cl. CPC F41H 11/10; B60D 1/243

(57) ABSTRACT

Systems, devices, and methods comprising a remote controlled unit having a body, wherein the remote controlled unit is in communication with a controller; and at least one tire deflation device coupled to the remote controlled unit by a tether, wherein the remote controlled unit deploys the at least one tire deflation device at a predetermined location.

### CROSS-REFERENCE TO RELATED APPLICATIONS

This patent application claims the benefit of U.S. Provisional Patent Application Ser. No. 63/598,625 filed on Nov. 14, 2023 and entitled “Remote Controlled Unit For Vehicular Tire Deflation Device,” the disclosure of which is hereby incorporated by reference herein in its entirety and made part of the present U.S. utility patent application for all purposes.

### BACKGROUND

Spike strips are oftentimes deployed manually on a roadway by law enforcement to disable a vehicle by puncturing the tires of the vehicle. However, manually setting a spike strip on a roadway is cumbersome and requires a person to approach or enter the roadway, thereby exposing the person to oncoming traffic and other roadway dangers. Accordingly, there is an ongoing need for systems, devices, and methods that can quickly deploy spike strips and other vehicular tire deflation devices on a roadway, while reducing potential roadway dangers exposed to police officers and other individuals.

### SUMMARY

The following provides a summary of certain example implementations of the disclosed technology. This summary is not an extensive overview and is not intended to identify key or critical aspects or elements of the disclosed technology or to delineate its scope. However, it is to be understood that the use of indefinite articles in the language used to describe and claim the disclosed technology is not intended in any way to limit the described technology. Rather the use of “a” or “an” should be interpreted to mean “at least one” or “one or more”.

One implementation of the disclosed technology provides a system, comprising a remote controlled unit having a body, wherein the remote controlled unit is in communication with a controller; and at least one tire deflation device coupled to the remote controlled unit by a tether, wherein the remote controlled unit deploys the at least one tire deflation device at a predetermined location.

In some implementations, the remote controlled unit further comprises at least one wheel coupled to a right side of the body; and at least one wheel coupled to a left side of the body, wherein the at least one wheel on the right side and the at least one wheel on the left side have a predetermined height that extends a distance above and below the body. The tether may comprise a first end and a second end, wherein the first end couples to the remote controlled unit, and the second end couples to the at least one tire deflation device. In various implementations, the system further comprises a coupling mechanism comprising a latch affixed to the remote controlled unit; and a hitch coupled to the tether, wherein the latch is configured to receive the hitch to couple the at least one tire deflation device to the remote controlled unit. In some implementations, the hitch is configured to break away from the latch when a predetermined amount of force is applied to the hitch, wherein the predetermined amount of force is at least 600 pounds. The latch may be configured in various implementations as a magnet, wherein the hitch magnetically couples to the latch. In some implementations, the remote controlled unit further comprises a first light positioned at a front side of the body; and a second light positioned at a rear side of the body, wherein the first and second lights are configured to provide a directional position of the remote controlled unit relative to an individual. The first light may emit a first light color and the second light may emit a second light color, wherein the first light color differs from the second light color.

Another implementation of the disclosed technology provides a system, comprising a remote controlled unit in communication with a controller; a coupling mechanism configured to couple at least one tire deflation device to the remote controlled unit, wherein the coupling mechanism comprises a latch affixed to the remote controlled unit; and a hitch, wherein the remote controlled unit deploys the at least one tire deflation device at a predetermined location.

In some implementations, the hitch is coupled to a tether having a first end a second end, wherein the hitch is coupled to the first end of the tether, and wherein the at least one tire deflation device is coupled to the second end of the tether. In various implementations, the hitch is configured to break away from the latch when a predetermined amount of force is applied to the hitch, wherein the predetermined amount of force is at least 600 pounds. The may be configured as a magnet in various implementations, wherein the hitch magnetically couples to the latch. In some implementations, the remote controlled unit further comprises a first light positioned at a front side of the body; and a second light positioned at a rear side of the body, wherein the first and second lights are configured to provide a directional position of the remote controlled unit relative to an individual. The first light may emit a first light color and the second light may emit a second light color, wherein the first light color differs from the second light color. In some implementations, the remote controlled unit further comprises a body; at least one wheel coupled to a right side of the body; and at least one wheel coupled to a left side of the body, wherein the at least one wheel on the right side and the at least one wheel on the left side have a predetermined height that extends a distance above and below the body.

Still another implementation of the disclosed technology provides a system for deploying tire deflation devices, comprising a remote controlled unit in communication with a controller; a tether coupled to a sleeve containing a plurality of tire deflation devices; and a coupling mechanism configured to couple the tether to the remote controlled unit, wherein the remote controlled unit deploys the at least one tire deflation device at a predetermined location.

In some implementations, the coupling mechanism comprises a latch affixed to the remote controlled unit; and a hitch coupled to the tether, wherein the latch is configured to receive the hitch to couple the plurality of tire deflation devices to the remote controlled unit. In some implementations, the hitch is configured to break away from the latch when a predetermined amount of force is applied to the hitch, and wherein the predetermined amount of force is at least 600 pounds. In various implementations, the remote controlled unit further comprises a first light positioned at a front side of the body; and a second light positioned at a rear side of the body, wherein the first and second lights are configured to provide a directional position of the remote controlled unit relative to an individual. The first light may emit a first light color and the second light may emit a second light color, wherein the first light color differs from the second light color.

Still another implementation of the disclosed technology provides a method, comprising coupling at least one vehicle tire deflation device to a remote controlled unit, wherein the remote controlled unit is in communication with a controller; placing the remote controlled unit on a roadway or similar surface; and by way of the controller, navigating the remote controlled unit to a first location such that the at least one vehicle tire deflation device contacts one or more tires of a vehicle.

In some non-limiting embodiments, the method further comprises subsequent to the at least one vehicle tire deflation device contacting the one or more tires of the vehicle, navigating the remote controlled unit and the at least one vehicle tire deflation device to a second location; and retrieving the remote controlled unit and the at least one vehicle tire deflation device at the second location. In one or more non-limiting embodiments, the method further comprises coupling the at least one vehicle tire deflation device to the remote controlled unit by way of a tether; coupling a first end of the tether to the remote controlled unit by way of a coupling mechanism, wherein the coupling mechanism comprises a latch affixed to the remote controlled unit; and a hitch coupled to the first end of the tether; and coupling a second end of the tether to the at least one vehicle tire deflation device by way of a carabiner. In some non-limiting embodiments, the hitch is configured to break away from the latch when a predetermined amount of force is applied to the hitch, wherein the predetermined amount of force is at least 600 pounds. In other non-limiting embodiments, the method further comprises identifying a first light positioned at a front side of the remote controlled unit; and identifying a second light positioned at a rear side of the remote controlled unit, wherein the first and second lights are configured to provide a directional position of the remote controlled unit relative to the individual. In some non-limiting embodiments, the first light emits a first light color and the second light emits a second light color, and the first light color differs from the second light color.

Still another implementation of the disclosed technology provides a method for remotely deploying at least one vehicle tire deflation device comprising coupling a sleeve containing at least one vehicle tire deflation device to a remote controlled unit, wherein the remote controlled unit is in communication with a controller; placing the remote controlled unit on a roadway or similar surface; and by way of the controller, navigating the remote controlled unit to a first location such that the at least one vehicle tire deflation device contacts one or more tires of a vehicle.

In one or more non-limiting embodiments, the method further comprises coupling the at least one vehicle tire deflation device to the remote controlled unit by way of a tether; coupling a first end of the tether to the remote controlled unit by way of a coupling mechanism, wherein the coupling mechanism comprises a latch affixed to the remote controlled unit; and a hitch coupled to the first end of the tether; and coupling a second end of the tether to the sleeve by way of a carabiner. In some non-limiting embodiments, the hitch is configured to break away from the latch when a predetermined amount of force is applied to the hitch, wherein the predetermined amount of force is at least 600 pounds. In other non-limiting embodiments, the method further comprises identifying a first light positioned at a front side of the remote controlled unit; and identifying a second light positioned at a rear side of the remote controlled unit, wherein the first and second lights are configured to provide a directional position of the remote controlled unit relative to the individual. In some non-limiting embodiments, the first light emits a first light color and the second light emits a second light color, and the first light color differs from the second light color.

It should be appreciated that all combinations of the foregoing concepts and additional concepts discussed in greater detail below (provided such concepts are not mutually inconsistent) are contemplated as being part of the technology disclosed herein and may be implemented to achieve the benefits as described herein. Additional features and aspects of the disclosed system, devices, and methods will become apparent to those of ordinary skill in the art upon reading and understanding the following detailed description of the example implementations. As will be appreciated by the skilled artisan, further implementations are possible without departing from the scope and spirit of what is disclosed herein. Accordingly, the drawings and associated descriptions are to be regarded as illustrative and not restrictive in nature.

### BRIEF DESCRIPTION OF THE DRAWINGS

The accompanying drawings, which are incorporated into and form a part of the specification, schematically illustrate one or more example implementations of the disclosed technology and, together with the general description given above and detailed description given below, serve to explain the principles of the disclosed subject matter, and wherein:

FIGS. 1A-1B are perspective views of an example implementation of the disclosed system having a remote controlled unit and a plurality of vehicular tire deflation devices tethered to the remote controlled unit;

FIG. 2 is a perspective view of the system of FIGS. 1A-1B in a fully deployed configuration;

FIG. 3 is a perspective view of the system of FIGS. 1A-1B in a fully deployed configuration in relation to a non-limiting, oncoming vehicle;

FIG. 4 is a top perspective view of the remote controlled unit of FIGS. 1A-1B, wherein the remote controlled unit comprises a body, a protective cover, and a plurality of drive wheels;

FIG. 5 is a top view of the remote controlled unit of FIG. 4;

FIG. 6 is a bottom view of the remote controlled unit of FIG. 4;

FIG. 7 is a left, front perspective view of the remote controlled unit of FIG. 4;

FIG. 8 is a right, front perspective view of the remote controlled unit of FIG. 4;

FIG. 9 is a top, rear perspective view of the remote controlled unit of FIG. 4, wherein a hitch is coupled to the remote controlled unit;

FIG. 10 is a bottom, rear perspective view of the remote controlled unit of FIG. 4, wherein the hitch is uncoupled from the remote controlled unit;

FIG. 11 depicts an exemplary carabiner attached to the hitch of FIG. 9, wherein the carabiner couples the plurality of vehicular tire deflation devices to the remote controlled unit;

FIG. 12 is a perspective view of the carabineer of FIG. 11 attached to the hitch, wherein the hitch is uncoupled from the remote controlled unit;

FIG. 13 is a bottom view of the remote controlled unit of FIG. 4 with the plurality of drive wheels removed;

FIG. 14 is a perspective view of an example implementation of the protective cover of FIG. 4 showing its exterior surface;

FIG. 15 depicts an interior surface of the exemplary protective cover of FIG. 14;

FIG. 16 is a top view of the body of FIG. 4 showing exemplary internal components of the remote controlled unit;

FIG. 17 is a detailed view of the body of FIG. 16; and

FIG. 18 is a schematic diagram of the remote deployment system of FIGS. 1A-1B, depicting a controller device and the remote controlled unit in electrical communication.

### DETAILED DESCRIPTION

Example implementations are now described with reference to the Figures. Reference numerals and labels are used throughout the detailed description to refer to the various elements and structures. Although the following detailed description contains many specifics for the purposes of illustration, a person of ordinary skill in the art will appreciate that many variations and alterations to the following details are within the scope of the disclosed technology. Accordingly, the following implementations are set forth without any loss of generality to, and without imposing limitations upon, the claimed subject matter.

The examples discussed herein are examples only and are provided to assist in the explanation of the apparatuses, devices, systems, and methods described herein. None of the features or components shown in the drawings or discussed below should be taken as required for any specific implementation of any of these the apparatuses, devices, systems or methods unless specifically designated as such. For ease of reading and clarity, certain components, modules, or methods may be described solely in connection with a specific Figure. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. Similarly, the use of the word “or” is intended to be non-exclusive unless the context clearly indicates otherwise. It will be further understood that the terms “comprises” or “comprising,” when used in this specification, specify the presence of stated features, integers, steps, operations, elements, or components, but do not preclude the presence or addition of one or more other features, integers, steps, operations, elements, components, or groups thereof.

Embodiments of the invention are described herein with reference to illustrations that are schematic illustrations of idealized embodiments (and intermediate structures) of the invention. As such, variations from the shapes of the illustrations as a result, for example, of manufacturing techniques or tolerances, are to be expected. Thus, embodiments of the invention should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The disclosed technology provides deployment systems, methods, and devices comprising a remote controlled unit and a plurality of vehicular tire deflation devices (“deflation devices”) tethered to the remote controlled unit that allows for the deployment and positioning of the deflation devices. The deflation devices may specifically be used to puncture and deflate vehicle tires. Law enforcement officers and other individuals risk their safety by manually deploying spike strips and other similar tire deflation devices, exposing themselves to oncoming vehicles, debris, and other roadway hazards. As such, the disclosed deployment system and methods advantageously allow officers or individuals to remotely deploy, and retrieve, deflation devices towards a target, such as a nearby roadway, for example. It should be appreciated that the disclosed system can be used in various applications beyond the deployment of deflation devices. Such applications may include, but are not limited to, law enforcement and private security support of traffic-control, parking-control, vehicle-control, border and/or city control, local boundary control, military munitions delivery, and military-support purposes.

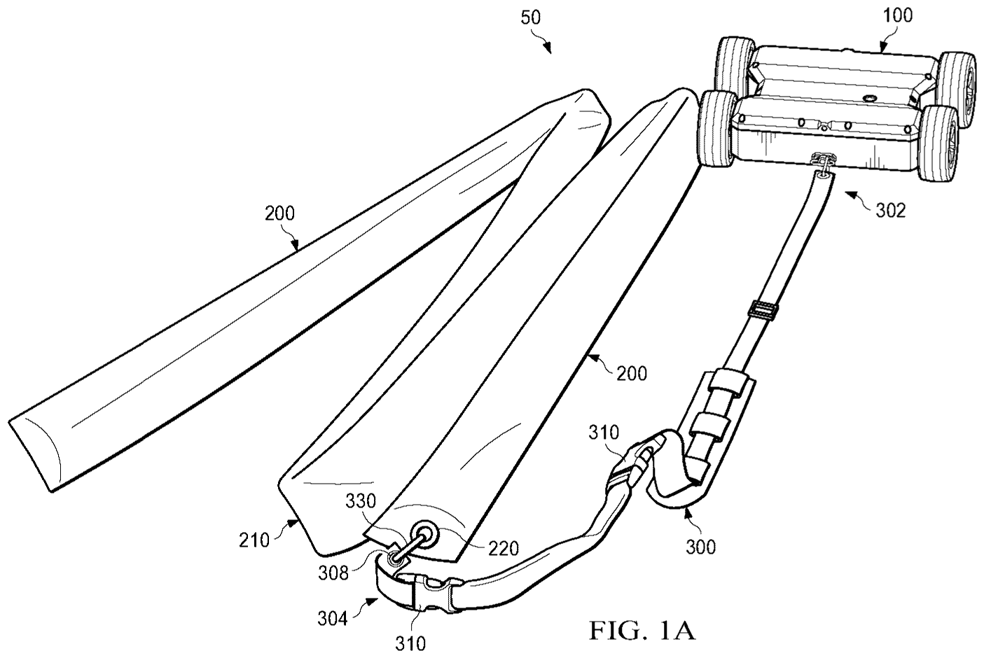

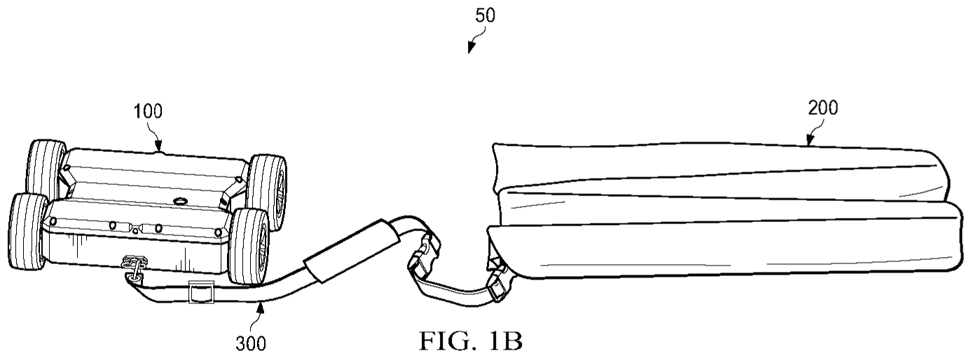

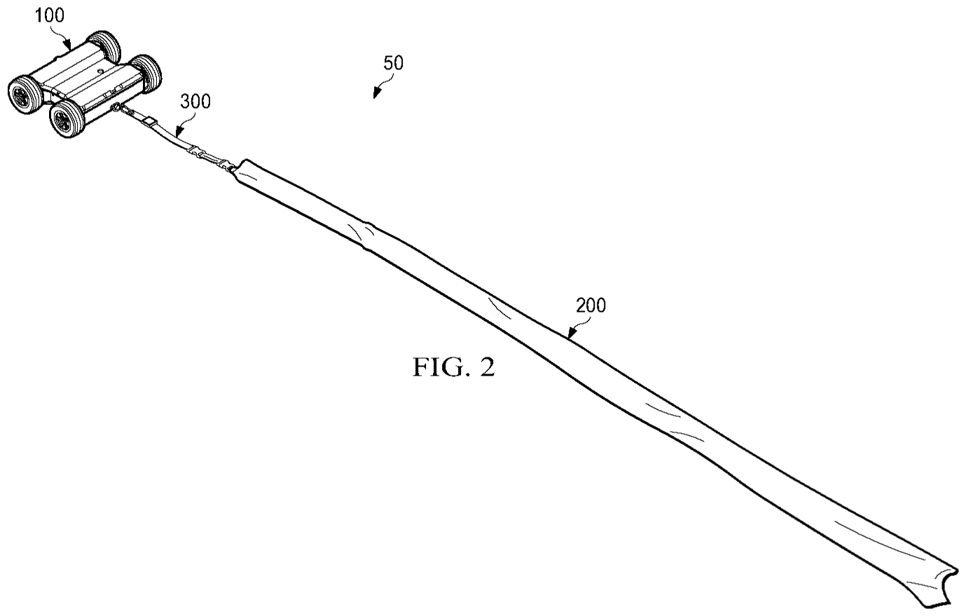

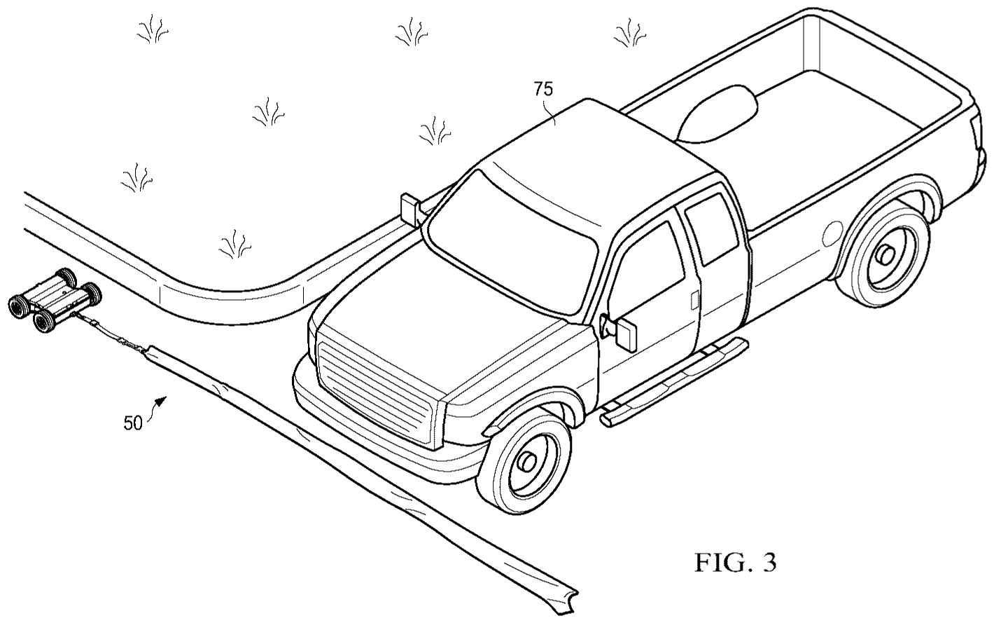

FIGS. 1A-1B are perspective views of an example implementation of the disclosed system having a remote controlled unit and a plurality of vehicular tire deflation devices tethered to the remote controlled unit; FIG. 2 is a perspective view of the system of FIGS. 1A-1B in a fully deployed configuration; and FIG. 3 is a perspective view of the system of FIGS. 1A-1B in a fully deployed configuration in relation to a non-limiting, oncoming vehicle. The vehicle tire deflation devices used with the disclosed systems and methods are illustrated and described in U.S. Pat. Nos. D710,233; 5,330,285; 5,820,293; 6,155,745; and 10,408,557, which are each expressly incorporated by reference herein and made part of this application for all purposes. In one non-limiting embodiment, the vehicle tire deflation devices used with the disclosed systems and methods comprise a body having an outer wall that defines a passageway that is substantially elongated; and a plurality of internal spikes disposed between the outer wall and the passageway such that each internal spike of the plurality of internal spikes is isolated from the passageway; wherein the passageway is configured to facilitate routing of a tether of a propulsion unit therethrough without contacting the plurality of internal spikes. In one or more embodiments, the disclosed vehicle tire deflation devices may be a first tire deflation device and a second tire deflation device, the first tire deflation device and the second tire deflation device each comprising a body having an outer wall that defines a passageway that is substantially elongated; and a plurality of internal spikes disposed between the outer wall and the passageway such that each internal spike of the plurality of internal spikes is isolated from the passageway. A tether may be routed through the passageway of each of the first tire deflation device and the tire deflation device, wherein the tether may be coupled with a distal end of the first tire deflation device, and the second tire deflation device may be configured to slide with respect to the tether.

With reference to FIGS. 1A-1B and 2-3, there is provided deployment system 50 comprising remote controlled unit 100 and a plurality of vehicular tire deflation devices 200 (“deflation devices”) coupled to remote controlled unit 100 by way of tether 300. Each of the plurality of deflation devices 200 are connected together within sleeve 210 (e.g. tether, rope, string, chain, etc.). In non-deployed configurations (FIGS. 1A-1B), the plurality of deflation devices 200 are folded within sleeve 210, whereas in deployed configurations (FIGS. 2-3), the plurality of deflation devices 200 are unfolded and substantially linear with one another under tension to align with and contact the tires of oncoming vehicle 75.

Still referring to FIGS. 1A-1B and 2-3, tether 300 includes first end 302 and second end 304. First end 302 includes aperture 306 that receives carabiner or similar fastener 320, and second end 304 includes aperture 308 that receives carabiner or similar fastener 330. Carabiner 320 is configured to couple to remote controlled unit 100, and carabiner 330 is configured to couple to aperture 220 formed on sleeve 210. Tether 300 further comprises one or more clips or similar connecting members 310 that are configured to: (i) quickly attach or detach tire deflation devices 200 to or from tether 300; and/or (ii) reduce or extend the length of tether 300. It is to be appreciated that carabiner 330 could attach directly to one or more of the deflation devices 200.

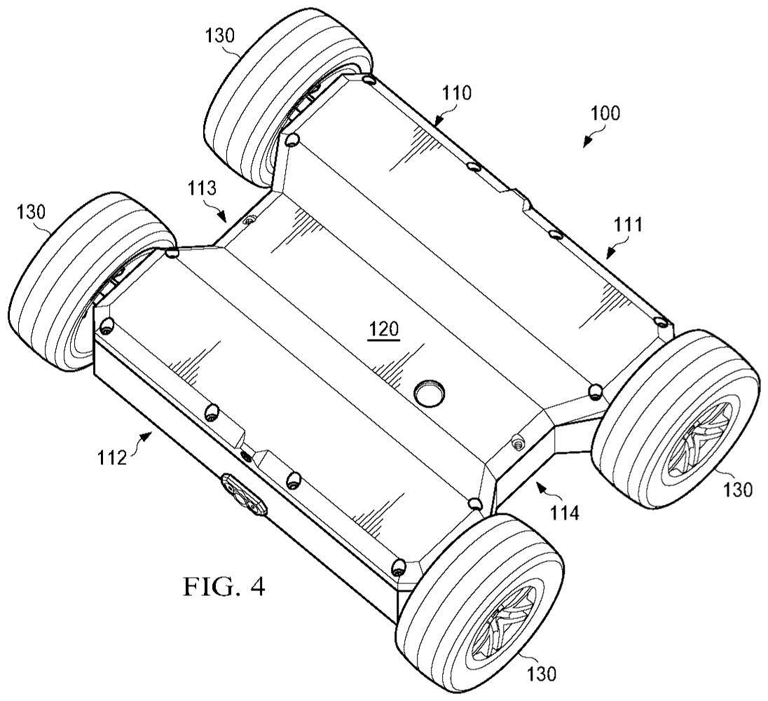

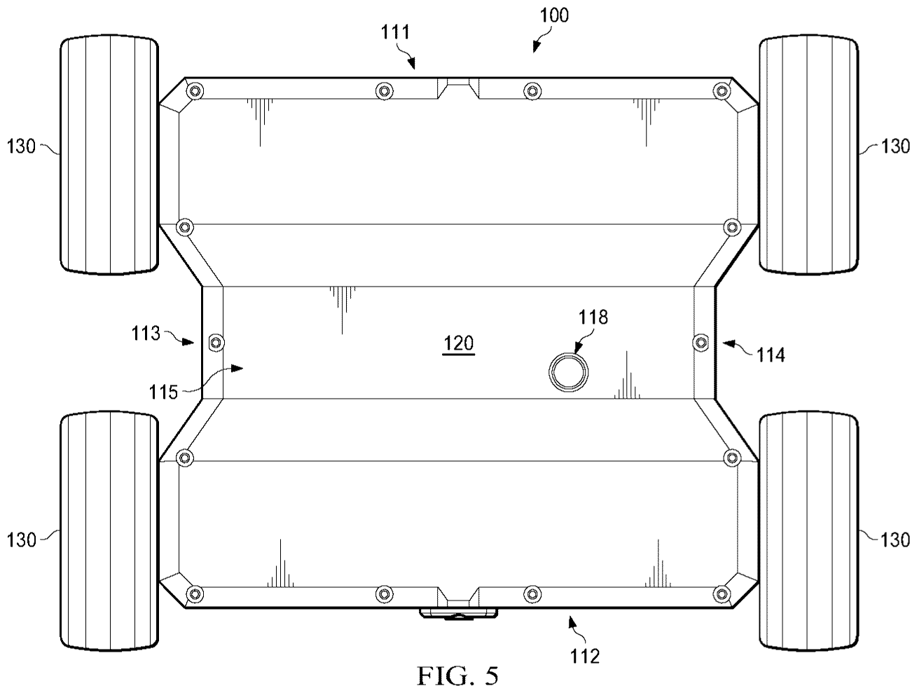

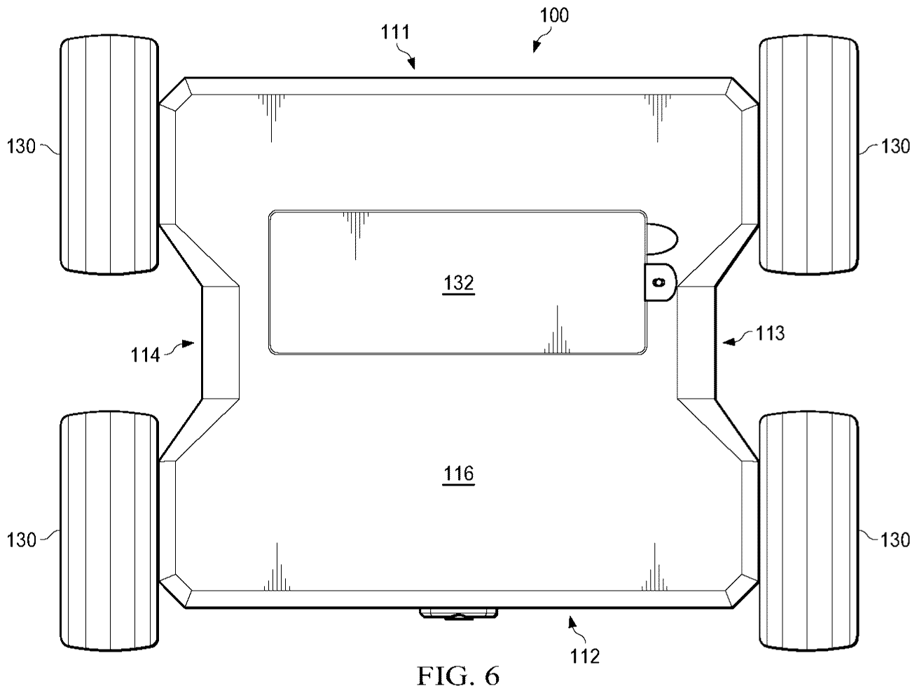

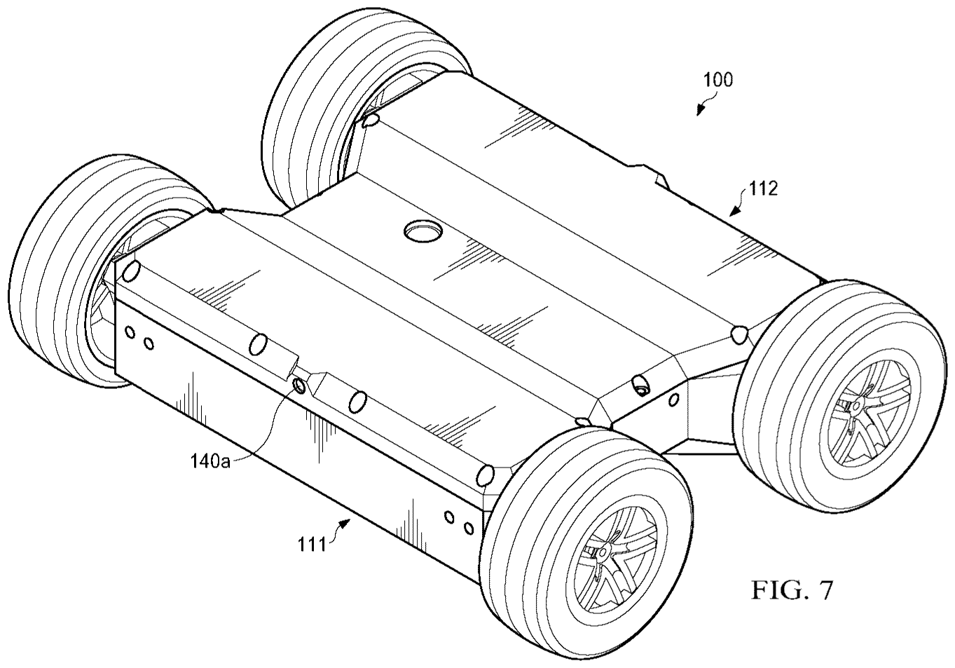

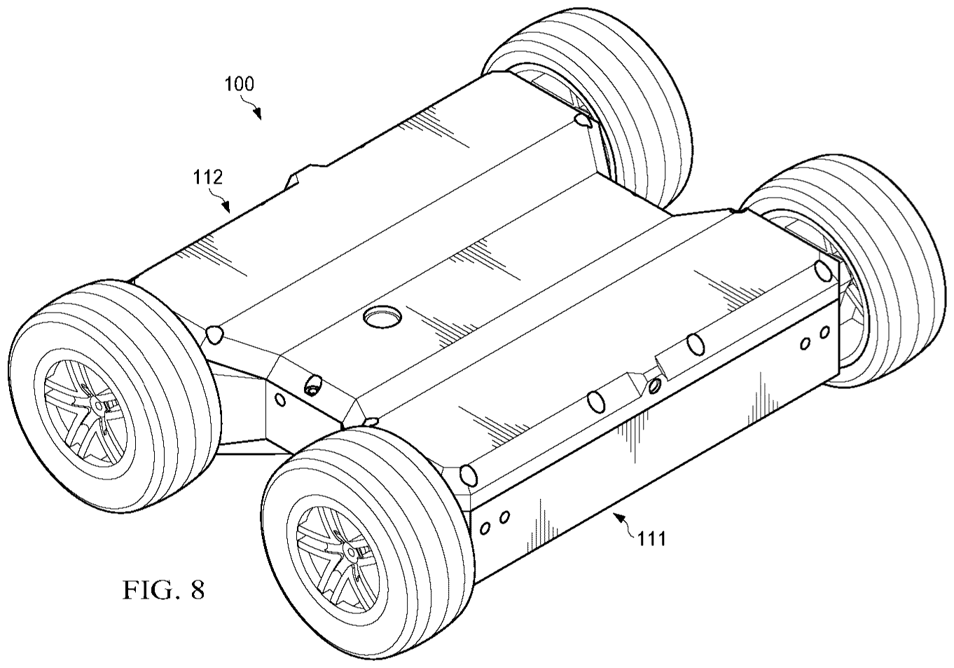

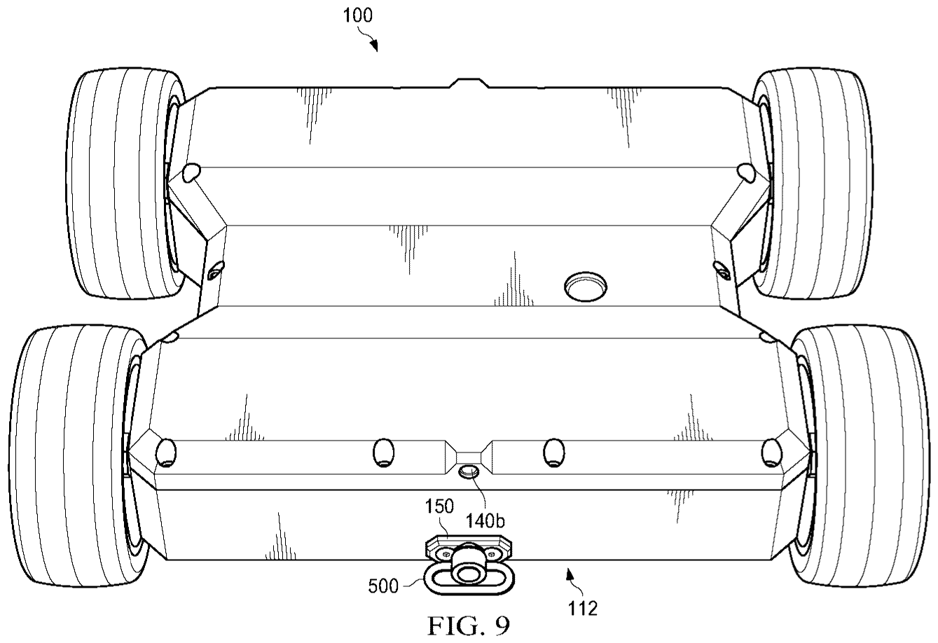

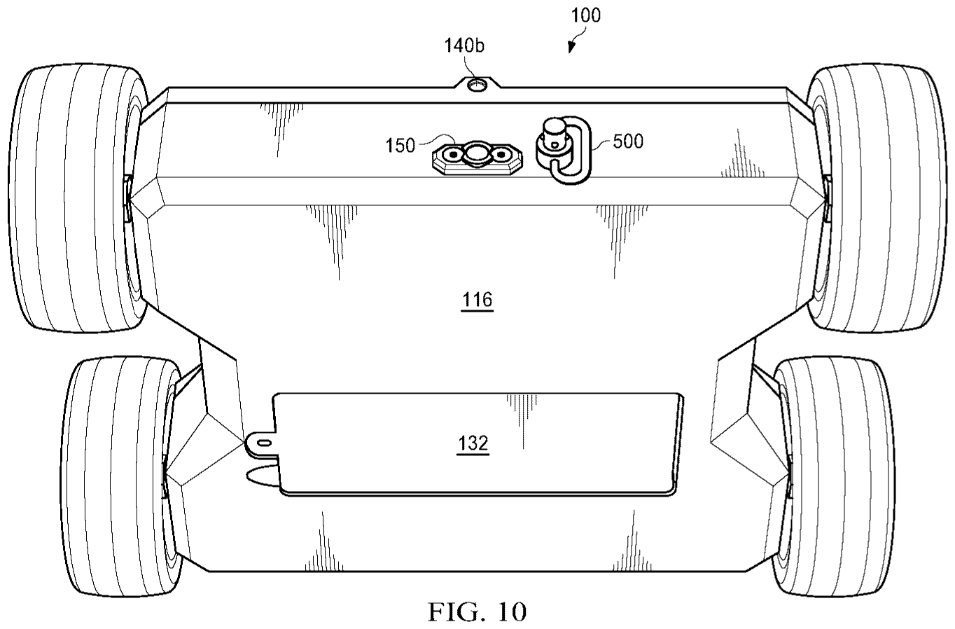

FIG. 4 is a top perspective view of the remote controlled unit of FIGS. 1A-1B, wherein the remote controlled unit comprises a body, a protective cover, and a plurality of drive wheels; FIG. 5 is a top view of the remote controlled unit of FIG. 4; FIG. 6 is a bottom view of the remote controlled unit of FIG. 4; FIG. 7 is a left, front perspective view of the remote controlled unit of FIG. 4; FIG. 8 is a right, front perspective view of the remote controlled unit of FIG. 4; FIG. 9 is a top, rear perspective view of the remote controlled unit of FIG. 4, wherein a hitch is coupled to the remote controlled unit; and FIG. 10 is a bottom, rear perspective view of the remote controlled unit of FIG. 4, wherein the hitch is uncoupled from the remote controlled unit.

With reference to FIGS. 4-10, remote controlled unit 100 comprises body 110, protective cover 120 coupled to body 110, and a plurality of drive wheels 130 rotatably coupled to body 110. Remote controlled unit 100 has a perimeter defining front side 111, rear side 112, left side 113, right side 114, top side 115, and bottom side 116. Each of the plurality of drive wheels 130 has a predetermined height that extends at a clearance distance above and below body 110 of unit 100, thereby allowing for continued operation should remote controlled unit 100 be placed or land upside down and/or allowing for unit 100 to travel across various terrains and conditions.

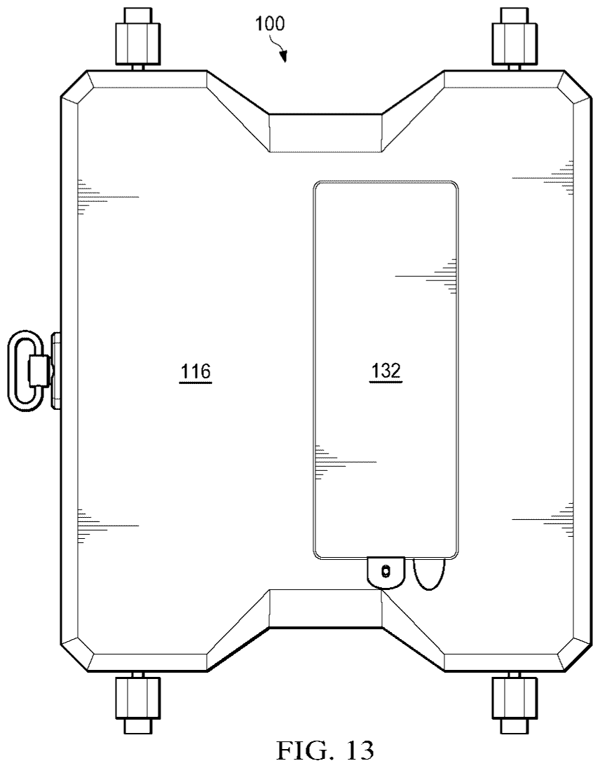

Still referring to FIGS. 4-10, bottom side 116 of remote controlled unit 100 includes door 132 that provides access to battery compartment 134 contained within remote controlled unit 100 (see also FIG. 13). Remote controlled unit 100 further comprises recessed ON/OFF power switch 118 to avoid accidental shutoff during use. Front side 111 includes front light 140a, and rear side 112 includes rear light 140b. Front and rear lights 140a, 140b (collectively, “directional assistance lights”) provide an officer or other individual with a directional arrow to determine where exactly unit 100 is facing and can assist with driving unit 100. Front and rear lights 140a, 140b can be activated or deactivated with switch 405 by a user on controller 400 (discussed in greater detail below).

In one non-limiting example, front light 140a emits a green light, and rear light 140b emits a red light. If the red light is visible, the officer understands remote controlled unit 100 is facing away from himself/herself; if the green is visible, the officer understands unit 100 is frontward facing. It is to be appreciated that front and rear lights 140a, 140b can be any color and/or could include any light effect as to indicate to a user the directional position of unit 100.

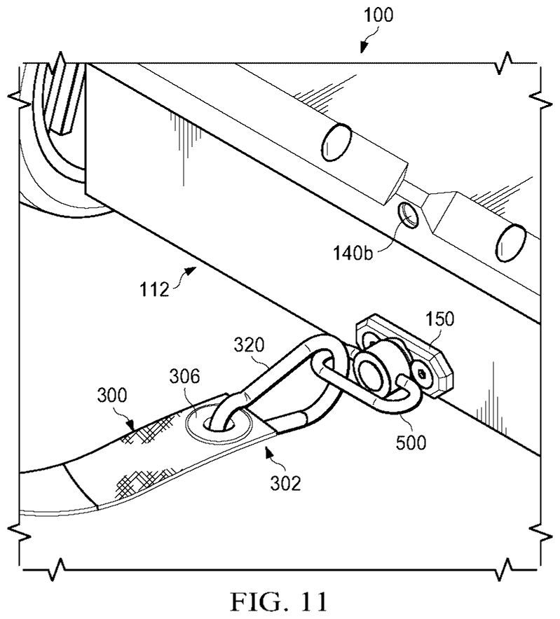

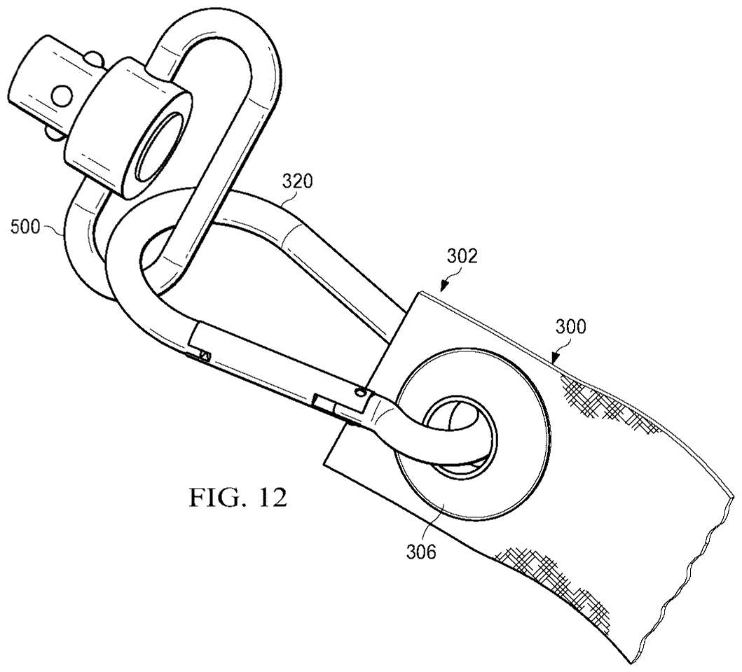

FIG. 11 depicts an exemplary carabiner attached to the hitch of FIG. 9, wherein the carabiner couples the plurality of vehicular tire deflation devices to the remote controlled unit; and FIG. 12 is a perspective view of the carabineer of FIG. 11 attached to the hitch, wherein the hitch is uncoupled from the remote controlled unit.

With reference to FIGS. 1-3 and 9-12, rear side 112 of remote controlled unit 100 further includes latch 150 configured to receive hitch 500. Latch 150 and hitch 500 cooperate together as a coupling mechanism to securely couple hitch 500 to latch 150. Hitch 500 can break away from latch 150 with a predetermined amount of applied pull or breakaway force. A press-fit configuration of latch 150 and hitch 500 allows a user to simply and quickly connect hitch 500 to latch 150 by pressing in hitch 500 until it clicks or is securely fastened within latch 150. First end 302 of tether 300 attaches to hitch 500 by way of carabiner 320.

Still referring to FIGS. 1-3 and 9-12, in some non-limiting embodiments, tether 300 is between about 6-9 inches in length (and all values and ranges therebetween). In some non-limiting embodiments, hitch 500 has a breakaway force of about 600 pounds. The length of tether 300 and the breakaway force of hitch 500 cooperate to protect remote controlled unit 100 from damage if, for example, deployment system 50 becomes entangled with approaching vehicle 75. If deployment system 50 becomes entwined with the vehicle's wheels at a force greater than or equal to about 600 pounds, hitch 500 will detach from latch 150 on remote controlled unit 100, thereby releasing remote controlled unit 100 from tire deflation devices 200. It should be appreciated that this configuration can also prevent remote controlled unit 100 from whipping up (or in any other direction) in response to one or more of deflation devices 200 being run over by vehicle 75.

In other non-limiting embodiments, latch 150 may be configured as a magnet or an electromagnet. In such embodiments, hitch 500 magnetically couples to latch 150 and breaks away from latch 150 when a predetermined amount of pull or breakaway force is applied.

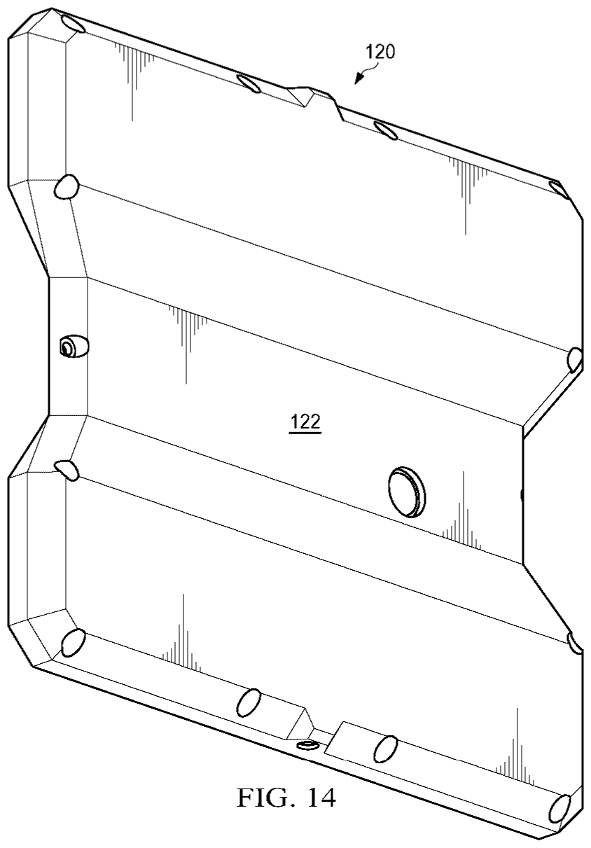

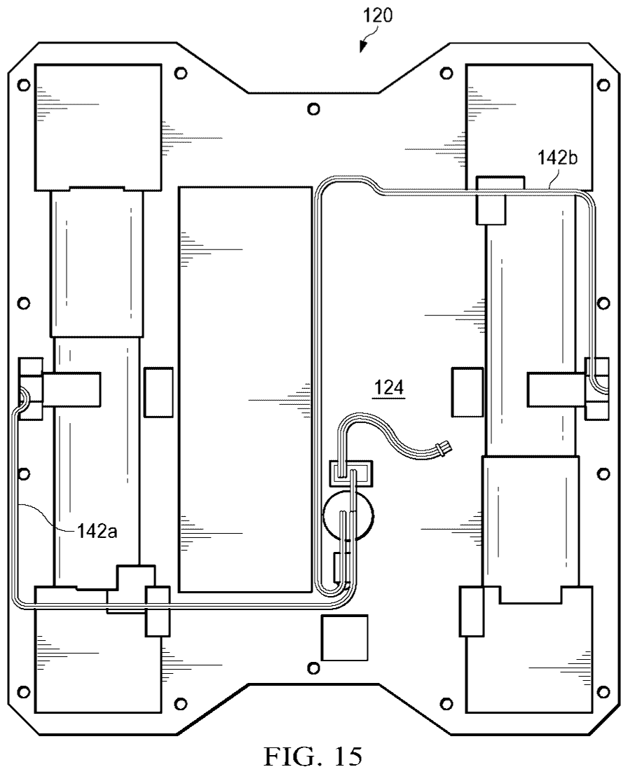

FIG. 13 is a bottom view of the remote controlled unit of FIG. 4 with the plurality of drive wheels removed; FIG. 14 is a perspective view of an example implementation of the protective cover of FIG. 4 showing its exterior surface; and FIG. 15 depicts an interior surface of the exemplary protective cover of FIG. 14.

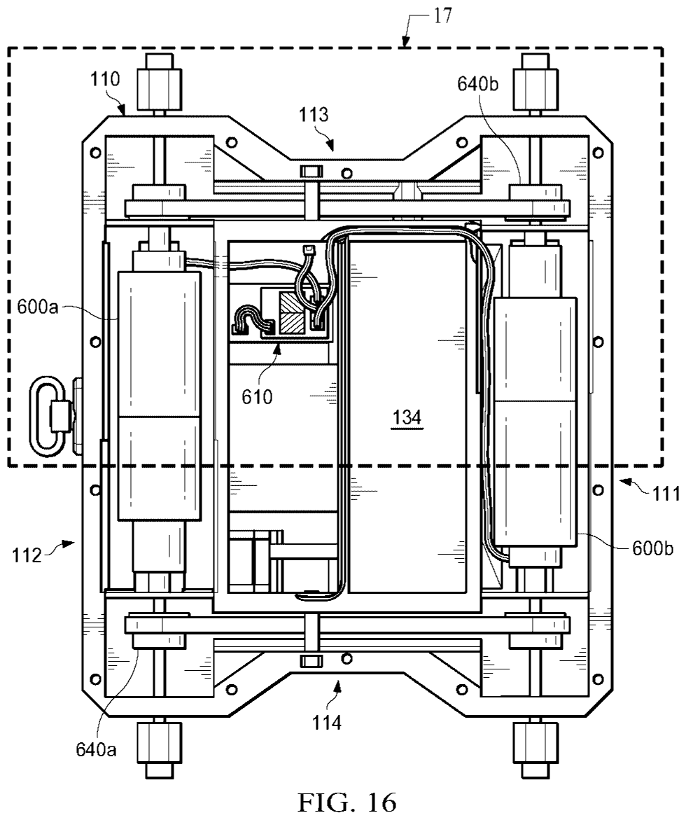

With specific reference to FIGS. 4 and 14-15, protective cover 120 includes exterior surface 122 and interior surface 124, wherein interior surface 124 couples to body 110 of remote controlled unit 100 to enclose and protect components housed within body 110 (see FIGS. 16-18 below) from damage. Electrical wiring 142a corresponding to front light 140a is routed along interior surface 124 of protective cover 120, and electrical wiring 142b corresponding to front light 140b is also routed along interior surface 124. Electrical wiring 142a, 142b is configured to be electrically connected to battery 625 (discussed below). It should be appreciated that protective cover 120 can also be configured to prevent the intrusion of liquids, dust, debris, or other foreign objects into the internal compartment(s) of remote controlled unit 100.

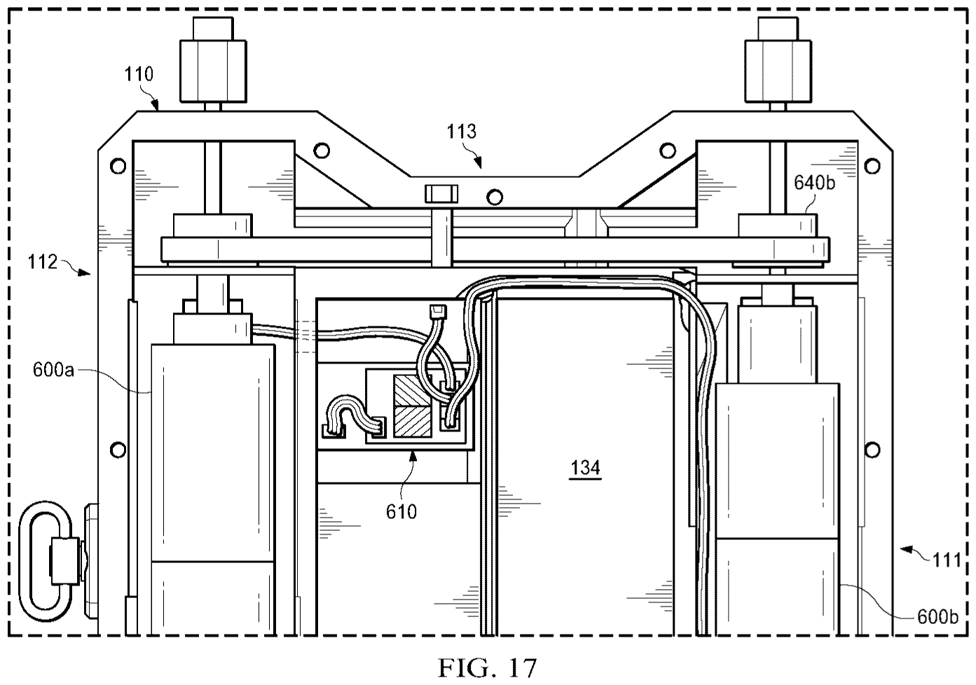

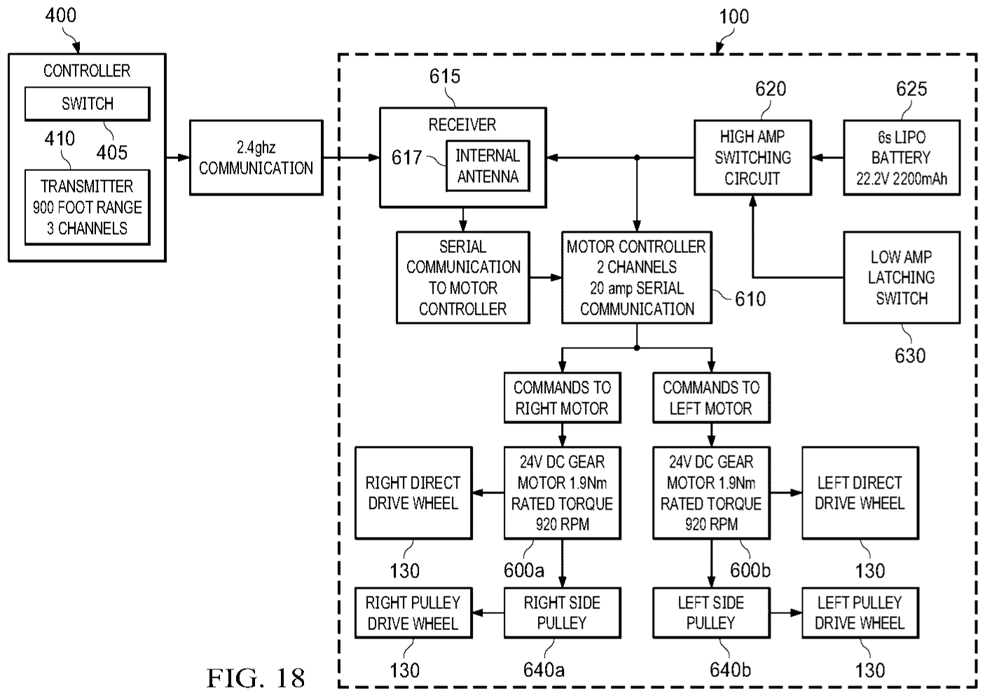

FIG. 16 is a top view of the body of FIG. 4 showing exemplary internal components of the remote controlled unit; FIG. 17 is a detailed view of the body of FIG. 16; and FIG. 18 is a schematic diagram of the remote deployment system of FIGS. 1A-1B, depicting a controller device and the remote controlled unit in electrical communication.

With reference to FIGS. 16-18, remote controlled unit 100 comprises the following components contained within body 110: first motor 600a and second motor 600b mechanically coupled to motor controller 610, wireless receiver 615 having internal antenna 617, and high ampere switching circuit 620. High ampere switching circuit 620 is in electrical communication with battery 625, low ampere latching switch 630, and motor controller 610. In the present non-limiting embodiment, first motor 600a controls the plurality of drive wheels 130 coupled to right side 114 of body 110, and second motor 600b controls the plurality of drive wheels 130 coupled to left side 113 of body 110. When commanded, first motor 600a supplies a predetermined force to one of the plurality of drive wheels 130 on right side 114 to: (i) rotate the first right side 114 drive wheel 130 relative to body 110; and (ii) engage first pulley (or belt, chain, etc.) 640a that activates the other right side 114 drive wheel 130. Similarly, when commanded, second motor 600b supplies a predetermined force to one of the plurality of drive wheels 130 on left side 113 to: (i) rotate the first left side 113 drive wheel 130 relative to body 110; and (ii) engage second pulley (or belt, chain, etc.) 640b that activates the other left side 113 drive wheel 130. This configuration allows remote controlled unit 100 to turn and spin in place, which may be needed in scenarios, for example, where unit 100 is unable to remove deflation devices 200 by driving perpendicular to the roadway due to some type of barrier, like a jersey barrier or a large body of water. Remote controlled unit 100 can be turned in place so it faces parallel to the roadway, and unit 100 can be driven until deflation devices 200 are cleared completely from the roadway.

With specific reference to FIG. 18, wireless controller device 400 comprises switch 405 and transmitter 410, wherein transmitter 410 is in communication with receiver 615 in remote controlled unit 100. Receiver 615 is in communication with motor controller 610. Battery 625 and low ampere latching switch 630 cooperate to power high amp switching circuit 620, wherein high amp switching circuit 620 communicates with receiver 615 and motor controller 610. Motor controller 610 commands first motor 600a to provide a predetermined force to one of the plurality of drive wheels 130 on right side 114 of body 110 and to first pulley or belt (right side pulley/belt/chain) 640a to activate the other right side 114 drive wheel 130. Motor controller 610 also commands second motor 600b to provide a predetermined force to one of the plurality of drive wheels 130 on left side 113 of body 110 and to second pulley or belt (left side pulley/belt/chain) 640b to activate the other left side 113 drive wheel 130. It is to be understood that wireless controller 400 can be any communication device such as a handheld controller, a computer, a smartphone, a tablet, a wearable computing device, or the like. It should be appreciated that the communication between wireless controller 400 and remote controlled unit 100 may be unidirectional or bidirectional, and may comprise digital or analog transmissions. In embodiments in which bidirectional communication exists between wireless controller 400, both the wireless controller 400 and remote controlled unit 100 may include appropriate transceivers.

In one exemplary embodiment of disclosed system 50, transmitter 410 in wireless controller 400 has about a 900 foot communication range with 3 radio frequency (RF) channels; battery 625 contained in remote controlled unit 100 is a 6 s LIPO battery having a voltage of 22.2V and a current of 2200 mAh; motor controller 610 may have 2 channels of 20 amp; and first and second motors 600a, 600b are each 24V DC gear motors, 1.9 Nm rated with a torque of 920 revolutions per minute (RPM). In another exemplary embodiments, first and second motors 600a. 600b are each 24V DC gear motors with a torque of 940 RPM. It is necessary to have enough torque in first and second motors 600a, 600b to move the deployment devices from a resting position, but not so much torque as to flip remote controlled unit 100. A controller logic may be used to ramp up first and second motors 600a, 600b to allow unit 100 to move without flipping over. Additionally, the torque speed needs to overcome about 40% of grade from berms and roadways. For example, the starting acceleration rate of remote controlled unit 100 can be configured to be slower for an initial period of operation, and then the acceleration rate can be increased (or otherwise adjusted) during for the remaining periods of operation.

Table 1 below lists exemplary specifications of disclosed remote controlled unit 100, having the registered name StickBot®.

TABLE 1
Remote Controlled Unit (StickBot ®) Specifications.

| | |
|---|---|
| StickBot ® Weight | Less than 20 pounds |
| Stick Bot ® Length | 15 inches |
| StickBot ® Width | 15 inches |
| StickBot ® Height | 6.75 inches |
| StickBot ® Speed Capability | 17.8 miles-per-hour |
| StickBot ® Drive Wheels | 4 |
| Operational Temp Range | −4 to 140° Fahrenheit |
| Rain/Moisture Exposure | IP 65 (rain and splash resistant) |
| Orientation Lights | 2 |
| Wireless Remote Controller | 2.4 gHz, range 800 feet |
| Storage Battery Life | 3 months |
| Standby Battery Life | 8 hours |
| Operating Battery Life | 30 minutes |
| Battery recharge time | 1 hour |

The disclosed tire deflation devices 200 can each have: (i) a length between about 12-15 feet (and all values and ranges therebetween); (ii) a weight between about 10-12 pounds (and all values and ranges therebetween); (iii) a deployment speed (i.e. the time it takes to position tire deflation devices 200 via unit 100 before an oncoming vehicle) between about 2-3 seconds (and all values and ranges therebetween); and (iv) a removal speed (i.e. the time it takes to remove tire deflation devices 200 via unit 100 after a vehicle passes and/or contacts the devices 200) between about 1.5-2 seconds (and all values and ranges therebetween).

In some exemplary embodiments, remote controlled unit 100, with the plurality of drive wheels 130 coupled thereto, has: a width of 390 mm or 39 cm or 15.35 inches; a length of 343 mm or 34.3 cm or 13.5 inches; and a height of 165 mm or 16.5 cm or 6.5 inches.

The disclosed remote controlled unit may include a handle or similar grippable device affixed to its body to aid in carrying and transporting remote controlled unit. The disclosed tire deflation devices, contained within their sleeve, may fit within a case or similar carrying enclosure to aid in transporting the tire deflation devices.

In one non-limiting method for deploying the deflation devices using the disclosed deployment system 50, the following steps are performed: (i) provide sleeve 210 containing at least one deflation device 200 therein; (ii) attach second end 304 of tether 300 to sleeve 210 by way of carabiner 330; (iii) provide remote controlled unit 100 having latch 150 formed thereon; (iv) press-fit hitch 500, that is coupled to first end 302 of tether 300, to latch 150; (v) operate controller 400 to navigate remote controlled unit 100 to a predetermined location such that the at least one deflation device 200 is positioned to contact the tires on vehicle 75; and (vi) subsequent to contacting the tires of vehicle 75, operate controller 400 to navigate remote controlled unit 100 to a second predetermined location that is a safe location for an individual to retrieve remote controlled unit 100 and device 200. It will be appreciated that tether 300 could couple directly to the at least one deflation device 200.

In another non-limiting method for deploying the deflation devices using the disclosed deployment system 50, the following steps are performed: (i) provide sleeve 210 containing at least one deflation device 200 therein; (ii) attach sleeve 210 to tether 300 by way of clip 310; (iii) provide remote controlled unit 100 having latch 150 formed thereon; (iv) attach hitch 500, that is coupled to first end 302 of tether 300, to latch 150; (v) operate controller 400 to navigate remote controlled unit 100 to a predetermined location such that the at least one deflation device 200 is positioned to contact the tires on vehicle 75; and (vi) subsequent to contacting the tires of vehicle 75, operate controller 400 to navigate remote controlled unit 100 to a second predetermined location that is a safe location for an individual to retrieve remote controlled unit 100 and device 200. It will be appreciated that tether 300 could couple directly to the at least one deflation device 200.

It will be appreciated that any of a variety of additional or alternative steps may be included in a method of using deployment system 50.

Having shown and described a preferred embodiment of the invention, those skilled in the art will realize that many variations and modifications may be made to affect the described invention and still be within the scope of the claimed invention. Additionally, many of the elements indicated above may be altered or replaced by different elements which will provide the same result and fall within the spirit of the claimed invention. It is the intention, therefore, to limit the invention only as indicated by the scope of the claim.

All literature and similar material cited in this application, including, but not limited to, patents, patent applications, articles, books, treatises, and web pages, regardless of the format of such literature and similar materials, are expressly incorporated by reference in their entirety. Should one or more of the incorporated references and similar materials differs from or contradicts this application, including but not limited to defined terms, term usage, described techniques, or the like, this application controls.

As previously stated and as used herein, the singular forms “a”, “an”, and “the” refer to both the singular as well as plural, unless the context clearly indicates otherwise. The term “comprising” as used herein is synonymous with “including”, “containing” or “characterized by” and is inclusive or open-ended and does not exclude additional, unrecited elements or method steps. Although many methods and materials similar or equivalent to those described herein can be used, particular suitable methods and materials are described herein. Unless context indicates otherwise, the recitations of numerical ranges by endpoints include all numbers subsumed within that range. Furthermore, references to “one implementation” are not intended to be interpreted as excluding the existence of additional implementations that also incorporate the recited features. Moreover, unless explicitly stated to the contrary, implementations “comprising” or “having” an element or a plurality of elements having a particular property may include additional elements whether or not they have that property.

The terms “substantially” and “about” describe and account for small fluctuations, such as due to variations in processing or operational ranges that are evident from the disclosure to those skilled in the art, for instance. For example, these terms can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%, or 0%.

Underlined or italicized headings and subheadings are used for convenience only, do not limit the disclosed subject matter, and are not referred to in connection with the interpretation of the description of the disclosed subject matter. All structural and functional equivalents to the elements of the various implementations described throughout this disclosure that are known or later come to be known to those of ordinary skill in the art are expressly incorporated herein by reference and intended to be encompassed by the disclosed subject matter. Moreover, nothing disclosed herein is intended to be dedicated to the public regardless of whether such disclosure is explicitly recited in the above description.

There may be many alternate ways to implement the disclosed technology. Various functions and elements described herein may be partitioned differently from those shown without departing from the scope of the disclosed technology. Generic principles defined herein may be applied to other implementations. Different numbers of a given module or unit may be employed, a different type or types of a given module or unit may be employed, a given module or unit may be added, or a given module or unit may be omitted.

Regarding this disclosure, the term “a plurality of” refers to two or more than two. Unless otherwise clearly defined, orientation or positional relations indicated by terms such as “upper” and “lower” are based on the orientation or positional relations as shown in the Figures, only for facilitating description of the disclosed technology and simplifying the description, rather than indicating or implying that the referred devices or elements must be in a particular orientation or constructed or operated in the particular orientation, and therefore they should not be construed as limiting the disclosed technology. The terms “connected”, “mounted”, “fixed”, etc. should be understood in a broad sense. For example, “connected” may be a fixed connection, a detachable connection, or an integral connection, a direct connection, or an indirect connection through an intermediate medium. For an ordinary skilled in the art, the specific meaning of the above terms in the disclosed technology may be understood according to specific circumstances.

It should be appreciated that all combinations of the foregoing concepts and additional concepts discussed in greater detail herein (provided such concepts are not mutually inconsistent) are contemplated as being part of the disclosed technology. In particular, all combinations of claimed subject matter appearing at the end of this disclosure are contemplated as being part of the technology disclosed herein. While the disclosed technology has been illustrated by the description of example implementations, and while the example implementations have been described in certain detail, there is no intention to restrict or in any way limit the scope of the appended claims to such detail. Additional advantages and modifications will readily appear to those skilled in the art. Therefore, the disclosed technology in its broader aspects is not limited to any of the specific details, representative devices and methods, and/or illustrative examples shown and described. Accordingly, departures may be made from such details without departing from the spirit or scope of the general inventive concept.

What is claimed:

1. A system, comprising:
(a) a remote controlled unit having a body, wherein the remote controlled unit is in communication with a controller; and
(b) at least one tire deflation device coupled to the remote controlled unit by a tether, wherein the remote controlled unit deploys the at least one tire deflation device at a predetermined location.

2. The system of claim 1, wherein the remote controlled unit further comprises:
(a) at least one wheel coupled to a right side of the body; and
(b) at least one wheel coupled to a left side of the body,
wherein the at least one wheel on the right side and the at least one wheel on the left side have a predetermined height that extends a distance above and below the body.

3. The system of claim 1, wherein the tether comprises a first end and a second end, wherein the first end couples to the remote controlled unit, and the second end couples to the at least one tire deflation device.

4. The system of claim 1, further comprising a coupling mechanism comprising:
(a) a latch affixed to the remote controlled unit; and
(b) a hitch coupled to the tether,
wherein the latch is configured to receive the hitch to couple the at least one tire deflation device to the remote controlled unit.

5. The system of claim 4, wherein the hitch is configured to break away from the latch when a predetermined amount of force is applied to the hitch, wherein the predetermined amount of force is at least 600 pounds.

6. The system of claim 4, wherein the latch is configured as a magnet, and wherein the hitch magnetically couples to the latch.

7. The system of claim 1, wherein the remote controlled unit further comprises:
(a) a first light positioned at a front side of the body; and
(b) a second light positioned at a rear side of the body,
wherein the first and second lights are configured to provide a directional position of the remote controlled unit relative to an individual.

8. The system of claim 7, wherein the first light emits a first light color and the second light emits a second light color, wherein the first light color differs from the second light color.

9. A system, comprising:
(a) a remote controlled unit in communication with a controller;
(b) a coupling mechanism configured to couple at least one tire deflation device to the remote controlled unit, wherein the coupling mechanism comprises:
(i) a latch affixed to the remote controlled unit; and
(ii) a hitch,
wherein the remote controlled unit deploys the at least one tire deflation device at a predetermined location.

10. The system of claim 9, wherein the hitch is coupled to a tether having a first end a second end, wherein the hitch is coupled to the first end of the tether, and wherein the at least one tire deflation device is coupled to the second end of the tether.

11. The system of claim 9, wherein the hitch is configured to break away from the latch when a predetermined amount of force is applied to the hitch, wherein the predetermined amount of force is at least 600 pounds.

12. The system of claim 9, wherein latch is configured as a magnet, and wherein the hitch magnetically couples to the latch.

13. The system of claim 9, wherein the remote controlled unit further comprises:
(a) a first light positioned at a front side of the body; and
(b) a second light positioned at a rear side of the body,
wherein the first and second lights are configured to provide a directional position of the remote controlled unit relative to an individual.

14. The system of claim 13, wherein the first light emits a first light color and the second light emits a second light color, wherein the first light color differs from the second light color.

15. The system of claim 9, wherein the remote controlled unit further comprises:
(a) a body;
(b) at least one wheel coupled to a right side of the body; and
(c) at least one wheel coupled to a left side of the body,
wherein the at least one wheel on the right side and the at least one wheel on the left side have a predetermined height that extends a distance above and below the body.

16. A system for deploying tire deflation devices, comprising:
(a) a remote controlled unit in communication with a controller;
(b) a tether coupled to a sleeve containing a plurality of tire deflation devices; and
(c) a coupling mechanism configured to couple the tether to the remote controlled unit, wherein the remote controlled unit deploys the at least one tire deflation device at a predetermined location.

17. The system of claim 16, wherein the coupling mechanism comprises:
(a) a latch affixed to the remote controlled unit; and
(b) a hitch coupled to the tether,
wherein the latch is configured to receive the hitch to couple the plurality of tire deflation devices to the remote controlled unit.

18. The system of claim 17, wherein the hitch is configured to break away from the latch when a predetermined amount of force is applied to the hitch, and wherein the predetermined amount of force is at least 600 pounds.

19. The system of claim 16, wherein the remote controlled unit further comprises:
(a) a first light positioned at a front side of the body; and
(b) a second light positioned at a rear side of the body,
wherein the first and second lights are configured to provide a directional position of the remote controlled unit relative to an individual.

20. The system of claim 19, wherein the first light emits a first light color and the second light emits a second light color, wherein the first light color differs from the second light color.
